(19) United States
(12) Patent Application Publication
(10) Pub. No.: US 2015/0355076 A1
(43) Pub. Date: Dec. 10, 2015

(54) FOULING PROBE FOR MEASURING FOULING IN A PROCESS FLUID

(71) Applicants: Athlon Solutions, LLC, Houston, TX (US); Phase Advanced Sensor Systems Corp., Edmonton (CA)

(72) Inventors: Paul Eaton, Houston, TX (US); Chris Michael Bjustrom Holt, Edmonton (CA)

(21) Appl. No.: 14/723,801

(22) Filed: May 28, 2015

Related U.S. Application Data
(60) Provisional application No. 62/008,299, filed on Jun. 5, 2014.

(51) Int. Cl. G01N 17/00

(52) U.S. Cl. CPC G01N 17/008

(57) ABSTRACT

A fouling test probe includes a chamber containing a plurality of test wires secured to a replaceable test wire assembly. An actuator selectively opens and closes inlet and outlet windows to the chamber, a controller controls the actuator and independently controls an amount of electrical current to each test wire, and a voltage sensor measures the voltage across each test wire. The test probe is disposed into a process fluid, the chamber is opened allow process fluid to flow through the chamber, and the chamber is closed to capture a sample of the process fluid within the chamber. An amount of electrical power is independently controlled to the test wires while the chamber is closed, and an amount of foulant accumulation on the test wires is determined, using heat transfer measurement to determine a fouling factor.

### CROSS-REFERENCE TO RELATED APPLICATIONS

This application is a U.S. Non-provisional patent application claiming priority of U.S. Provisional Patent Application Ser. No. 62/008,299 filed on Jun. 5, 2014, which application is incorporated by reference herein.

### BACKGROUND

1. Field of the Invention

The present invention relates to a system, apparatus and method for conducting a fouling test in an operating process plant, such as measuring a fouling rate in a process stream.

2. Background of the Related Art

Fouling refers to processes by which a material accumulates on solid surfaces of an apparatus in a way that interferes with the intended function of the apparatus. The fouling material may be organic, inorganic, biological, or some combination. A fouling rate may be described as an amount of deposition on a given surface area per unit of time, such as kilograms of deposit per square meter of surface area per second.

The primary cause of the fouling of solid surfaces used to heat processed fluids is that the fluids are degraded when exposed at elevated surface temperatures, forming solids or semisolids in the form of polymers, coke, salts, and other inorganics. As the solids accumulate on the surfaces of process equipment, heat transfer is reduced and the performance of the equipment falls off to the extent that the desired process change is no longer achievable. For example, in a refinery heat exchangers are used to heat crude oil above the boiling point of its various fractions, which on condensing, allows for the separation and collection of components into gasoline, diesel, and other desirable products. When fouling reduces the heat transfer so much that the temperature needed for separation cannot be achieved, then the products cannot be recovered.

Such fouling may be controlled by periodic cleaning, the addition of chemical fouling inhibitors or the careful control of process temperatures, pressures, fluid compositions and flow velocities.

### BRIEF SUMMARY

The reduction in heat transfer described above is a direct function of the amount of fouling and can be used as an in-situ fouling measurement. However, heat transfer measurements are difficult because there are so many variables, other than fouling deposits, which have a major influence on the rate of heat transfer. Some of these other variables include fluid velocity, fluid composition, fluid temperature and system pressure, all of which could have more effect on heat transfer than the fouling deposit itself. Therefore, it is critical to be able to negate these variables and only look at the deposit amount. Embodiments of the present invention make a heat transfer measurement on a clean probe at known conditions and then subtract out the other effects from a heat transfer measurement on a probe that has experienced fouling. The way to produce a known velocity is to isolate a volume of fluid from the process stream and render the velocity zero.

One embodiment of the present invention provides a fouling test probe comprising a chamber containing a plurality of test wires, wherein the plurality of test wires are secured to a replaceable test wire assembly. The fouling test probe further comprises an actuator for selectively opening and closing inlet and outlet windows to the chamber, a controller controlling the actuator and independently controlling an amount of electrical current to the each of the plurality of test wires, and a voltage sensor for measuring the voltage across each test wire and providing a voltage signal to the controller.

Another embodiment of the present invention provides a method of conducting a fouling test comprising positioning a test probe into a process fluid, wherein the test probe includes a test chamber containing a plurality of test wires, and wherein the test chamber includes an inlet window on a first side of the test chamber and an outlet window on a second side of the test chamber. The method further comprises opening the inlet and outlet windows to allow process fluid to flow through the chamber, closing the inlet and outlet windows to capture a sample of the process fluid within the chamber, independently controlling an amount of electrical current to one or more of the test wires while the inlet and outlet windows are closed, and determining an amount of foulant accumulation on the one or more test wires. The fouling measurement is thus made when the window is closed, causing the velocity to be zero. The window is opened in order to collect a fresh oil sample and closed again for the next fouling measurement.

### BRIEF DESCRIPTION OF THE SEVERAL VIEWS OF THE DRAWINGS

FIGS. 1A-1B are diagrams of a fouling probe before and after positioning into a process stream.

FIGS. 2A-2B are cross-sectional and perspective views of a fouling probe and a linear actuator positioning a test chamber in a closed position, during which a fouling measurement is taken.

FIGS. 3A-3B are cross-sectional and perspective views of the fouling probe of FIGS. 2A-2B when the linear actuator has positioned the test chamber in an open position, and a fresh oil sample is taken and no fouling measurement is made.

FIGS. 4A-4B are cross-sectional and perspective views of a fouling probe and a rotary actuator positioning a test chamber in a closed position, during which a fouling measurement is taken.

FIGS. 5A-5B are cross-sectional and perspective views of the fouling probe of FIGS. 4A-4B when the rotary actuator has positioned the test chamber in an open position and a fresh oil sample is taken with no fouling measurement being made.

FIGS. 6A-6C are perspective views of three replaceable test wire assemblies, where the test wires in FIG. 6A have a rectangular cross-section, the test wires in FIG. 6B have a circular cross-section, and the test wires in FIG. 6C are formed directly on a flat substrate.

FIG. 7 is a diagram of a control system for a fouling probe.

FIGS. 8A-8B are schematic diagrams of a test wire before and after accumulation of foulant on the surface of the test wire.

FIG. 9 is a diagram of a multimedia file server 100 that may be utilized consistent with one or more embodiments of the present invention.

### DETAILED DESCRIPTION

One embodiment of the present invention provides a fouling test probe comprising a chamber containing a plurality of test wires, wherein the plurality of test wires are secured to a replaceable test wire assembly. The fouling test probe further comprises an actuator for selectively opening and closing inlet and outlet windows to the chamber, a controller controlling the actuator and independently controlling an amount of electrical current to the each of the plurality of test wires, and a voltage sensor for measuring the voltage across each test wire and providing a voltage signal to the controller.

The test wires are precisely manufactured within close dimensional tolerances so that the resistance of each test wire is accurately known and has a defined relationship with the temperature of the test wire. The fouling test probe extends into a process stream containing the process fluid to be tested, such as a hydrocarbon fluid stream. When the actuator opens the inlet and outlet windows, the process fluid fills the chamber such that the test wires come into contact with the process fluid. When the actuator closed the inlet and outlet windows, an electrical current is provided through one or more of the test wires in order to carry out a fouling test on the process fluid.

The test wires may take various forms, such as having a cross-section selected from, without limitation, rectangular and circular. Furthermore, the test wires may extend between two electrically conductive posts or be disposed directly on an electrically nonconductive substrate. Optionally, each of the test wires used in the fouling test probe may have the same length and cross-sectional dimensions. In a separate option, each of the test wires used in the fouling test probe may be made with the same material, such as nickel, 316 stainless steel, and steel. The length of each test wire is preferably between 1 and 10 millimeters, more preferably between 1 and 5 millimeters, and most preferably between 1.5 and 3 millimeters. The amount of electrical current to each of the test wires is preferably less than 5 watts. By keeping the amount of electrical power low, the amount of heat added to the sample of process fluid will not significantly change the temperature of the sample from the temperature of the process fluid outside the chamber. Non-limiting examples of a suitable test wire include a microfabricated beam, microthreaded wire, or microfabricated anchored beam. Specific examples include a microfabricated released nickel beam having a length of 2 mm and a rectangular cross-section that is 100 μm wide×20 μm thick, a microthreaded wire made of 316 Stainless Steel or 9cr-2mo or steel having a length of 2 mm and a circular cross-section with a diameter of 76 μm, and a microfabricated anchored nickel beam having a length of 2 mm and a rectangular cross-section that is 100 μm wide and 1 μm thick. The test wire may be made from any metal or metal alloy, so long as its resistance changes with temperature in a reproducible manner.

The replaceable test wire assembly may include an electrically non-conductive base plate securing a plurality of electrically conductive posts extending from the base plate, wherein each of the test wires has a first end coupled to a first one of the electrically conductive posts and a second end coupled to a second one of the electrically conductive posts. The replaceable test wire assembly preferably also includes an electrical connector for disconnectably connecting the plurality of electrically conductive posts to a plurality of conductor wires for independently providing electrical current to the each of the test wires. The beams/wires may be secured to the posts by spot welding and the posts may be secured in the base plate by moulding the posts into the base plate, using high temperature epoxy or glass seal.) Where the test wires are disposed directly on an electrically non-conductive substrate, each end of the test wire may be coupled to an electrically conductive post that is coupled to an electrical connector for disconnectably connecting the plurality of electrically conductive posts to a plurality of conductor wires for independently providing electrical current to the each of the test wires. The test probe may be replaced in response to each of the test wires having been used to perform a fouling test. Preferably, replacing the test probe involves removing the test probe from the process stream, replacing the used replaceable test wire assembly with an unused replaceable test wire assembly, and returning the test probe into the process stream. A replaceable test wire assembly may have any number of test wires, such as from 1 to 25 test wires, or more particularly from 3 to 10 test wires.

The actuator is optionally a linear actuator. For example, the chamber may be formed by inner and outer concentric cylinders, wherein the inner concentric cylinder secures the one or more test wires, has a closed end and forms opposing inlet and outlet windows radially separated by cylindrical walls, wherein the outer concentric cylinder forms opposing inlet and outlet windows radially separated by cylindrical walls, and wherein the chamber is open to process fluid by extending the inner concentric cylinder to align the inlet and outlet windows of the inner concentric cylinder with the inlet and outlet windows of the outer concentric cylinder and closed to process fluid by retracting the inner concentric cylinder to align the inlet and outlet windows of the inner concentric cylinder with cylindrical walls of the outer concentric cylinder.

In another option, the actuator may be a rotary actuator. For example, the chamber may be formed by inner and outer concentric cylinders, wherein the inner concentric cylinder secures the one or more test wires and forms opposing inlet and outlet windows radially separated by cylindrical walls, and wherein the outer concentric cylinder forms opposing inlet and outlet windows radially separated by cylindrical walls. The chamber is open to process fluid by radially aligning the inlet and outlet windows of the outer concentric cylinder with the inlet and outlet windows of the inner concentric cylinder and the chamber is closed to process fluid by radially aligning the cylindrical walls of the outer concentric cylinder with the inlet and outlet windows of the inner concentric cylinder. Either of the linear actuator or rotary actuator may, for example, be powered by supplying electricity to an electric motor or by supply pressurized air a diaphragm.

Another embodiment of the present invention provides a method of conducting a fouling test comprising positioning a test probe into a process fluid, wherein the test probe includes a test chamber containing a plurality of test wires, and wherein the test chamber includes an inlet window on a first side of the test chamber and an outlet window on a second side of the test chamber. The method further comprises opening the inlet and outlet windows to allow process fluid to flow through the chamber, closing the inlet and outlet windows to capture a sample of the process fluid within the chamber, independently controlling an amount of electrical current to one or more of the test wires while the inlet and outlet windows are closed, and determining an amount of foulant accumulation on the one or more test wires.

The method may further include measuring the voltage on each of the one or more test wires. Accordingly, an amount of foulant accumulation on the one or more test wires may be determined by calculating the foulant accumulation as a function of the controlled amount of electrical current and the measured voltage. The calculation of foulant accumulation may also be a function of the process fluid temperature.

The amount of electrical current provided to the one or more test wires may be independently controlled to cause the one or more test wires to reach a different target temperature. Accordingly, the one or more test wires may be independently controlled to perform simultaneous fouling tests. Alternatively, the plurality of test wires may be independently controlled to perform sequential fouling tests. For example, sequential fouling tests may be performed automatically at regular intervals.

Optionally, the method may further include opening the inlet and outlet windows to allow the process fluid to flow through the chamber and flush out the sample of process fluid from a first fouling test, and closing the inlet and outlet windows to capture a second sample of the process fluid within the chamber. When the chamber is small, the foulant concentration in a captured sample may decline to the point that the sample is no longer representative of the process fluid. By capturing a second sample, the fouling test is more accurate. Still, it is important to close the chamber during the heating of the one or more test wires, since allowing the process fluid to continuously flow through the chamber would affect the heat transfer from the test wires and prevent the probe from making accurate fouling measurements.

In a further option, the inlet and outlet windows may be opened to allow the process fluid to flow through the chamber and flush out the sample of process fluid from a first fouling test, and then closed to capture a second sample of the process fluid within the chamber. Then, an amount of electrical current to one or more other test wires is independently controlled while the inlet and outlet windows are closed. An amount of accumulation of foulant on the one or more other test wires may then be determined.

Embodiments of the present invention allow monitoring of fouling in operating refineries, petrochemical plants, and other facilities that have hydrocarbon containing process fluids. For example, the fouling test probe may be used to perform real-time measurement of total fouling buildup or a rate of fouling deposition. The fouling test probe is able to control the fluid flow and perform the fouling test in static fluid conditions. One or more test wire is electrically heated using a small amount of electrical current to generate a fouling deposit that is measured in-situ. By keeping the wattage low, such as less than 5 watts, the use of the probe does not present a safety hazard.

As deposits form on the surface of a test wire, the heat transfer from the surface of the test wire is reduced and can be related to a fouling factor, which in turn is proportional to the amount of deposition on the test probe wire. In reference to FIG. 8A, heat is transferred from a clean hot surface to oil according to:

$${Q}_{clean} = ( {U}_{clean} ) * ( {A}_{clean} ) * ( {T}_{probe} - {T}_{oil} )$$

$$\frac{1}{{U}_{clean}} = \frac{1}{h} where h = convective heat transfer coefficient$$

$$h = {f}_{1} ( {R}_{e} , {P}_{r} )$$

$${P}_{r} = Prandtl number = {f}_{2} ( heat cap , visc , thermal conductivity ) = \frac{c μ}{k}$$

$${R}_{e} = Reynolds Number = {f}_{3} ( density , velocity , geom , visc ) = \frac{dv ρ}{μ}$$

As deposits accumulate on the surface of the test wire, there is an increase in the resistance to heat transfer from the surface of the test wire. Therefore, in reference to FIG. 8B, heat is transferred from the dirty (fouled) hot surface to oil according to:

$${Q}_{dirty} = {U}_{dirty} * {A}_{dirty} * {( {T}_{probe} - {T}_{oil} )}_{dirty} = dirty heat flux$$

$$\frac{1}{U} = \frac{1}{h} + \frac{X}{K} analogous to electric theory , {}^{``} resistors in {paarallel}^{″}$$

$$X = deposit thickness$$

$$K = deposit thermal conductivity$$

Accordingly, a fouling factor may be describes as:

$$FF = fouling factor = \frac{X}{K} = ( \frac{1}{{U}_{dirty}} ) - ( \frac{1}{{U}_{clean}} )$$

$$FF = fouling factor = \frac{\frac{btu}{hr}}{{ft}^{2} * hr * ° F .} - 1$$

$${U}_{fouled} = heat transfer coefficient , fouled = \frac{\frac{btu}{hr}}{{ft}^{2} * hr * ° F .}$$

$${U}_{clean} = heat transfer coefficient , clean = \frac{\frac{btu}{hr}}{{ft}^{2} * hr * ° F .}$$

$$Therefore \text{:} Fouling factor = FF = [ {A}_{dirty} * \frac{{( {T}_{probe} - {T}_{oil} )}_{dirty}}{{Q}_{dirty}} ] - [ {A}_{clean} * \frac{{( {T}_{probe} - {T}_{oil} )}_{clean}}{{Q}_{clean}} ]$$

$$A = heat transfer area ( {ft}^{2} )$$

$$Assume {A}_{dirty} = {A}_{clean} = A$$

Converting btu/hr to watts allows the fouling factor to be expressed in terms of measurable test parameters according to:

$$FF = ( 3.412 * A ) * [ ( \frac{{( {T}_{pro} - {T}_{oil} )}_{dirty}}{{( Amps * Volts )}_{dirty}} ) - ( \frac{{( {T}_{probe} - {T}_{oil} )}_{clean}}{{( Amps * Volts )}_{clean}} ) ] \qquad Eq ( 1 )$$

The fouling factor can be determined from equation (1), which makes use of the temperature of the oil and test wire, resistance (voltage/current) over the test wire and the surface area of the test wire. The clean condition is measured before fouling has begun, and is assumed to remain constant. The dirty condition is determined by continuous measurement of the test parameters throughout the fouling test, during which deposits are building on the surface of the test wire. Therefore, the other parameters which affect heat transfer are subtracted from the measurement and effectively negated.

When running a fouling test there are two modes of operation that can be used. For constant temperature operation, current is applied and the test wire rises to a selected starting temperature, and then the controller is set to maintain the starting temperature throughout the test. As fouling deposits accumulate, the probe current required for a constant temperature declines, and the fouling factor increases with fouling, according to equation (1). A plot of fouling factor versus time is used to develop a “fouling curve” and this data is used to monitor fouling. For constant heat flux operation, a level of heat flux is applied sufficient to bring the test wire to the desired temperature. This heat flux is maintained constant throughout the remainder of the test by applying a constant current, during which time the surface temperature of the test wire rises as a result of the insulating properties of the fouling deposit, and the fouling factor rises accordingly, again as in equation (1). The disclosure of U.S. Pat. No. 4,910,999 is incorporated by reference herein.

A test wire calibration (ohms vs. temperature) allows the wire temperature to be known as a function of the electrical resistance. Accordingly, the fouling probe uses a test wire having precise dimensions and materials, such that the function of resistance vs. temperature is well characterized. Thus, there is no need to separately calibrate each individual test wire.

Yet another embodiment of the present invention provides a computer program product for conducting a fouling test, the computer program product comprising a computer readable storage medium having program instructions embodied therewith, wherein the program instructions are executable by a processor to cause the processor to perform a method. The method comprises opening inlet and outlet windows in a test chamber to allow process fluid to flow through the chamber, closing the inlet and outlet windows to capture a sample of the process fluid within the chamber, independently controlling an amount of electrical current to one or more of the test wires exposed to the sample of the process fluid within the chamber while the inlet and outlet windows are closed, and determining an amount of foulant accumulation on the one or more test wires.

The foregoing computer program product may further include program instructions for implementing or initiating any one or more aspects of the methods described herein. Accordingly, a separate description of the methods will not be duplicated in the context of a computer program product.

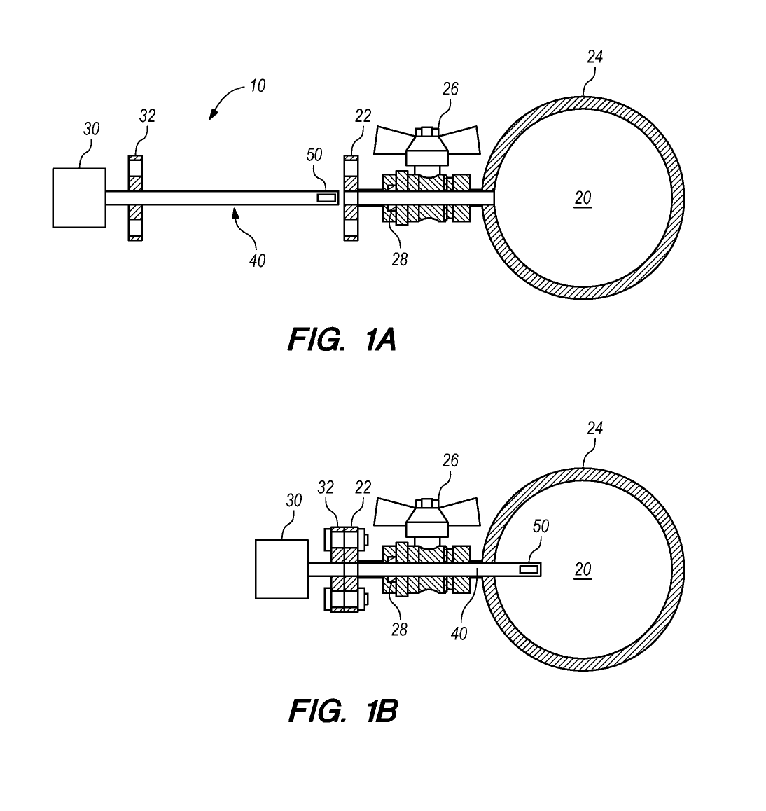

FIGS. 1A-1B are diagrams of a fouling probe 10 before and after positioning into a process stream 20. As shown in FIG. 1A, the fouling probe 10 includes an actuator 30, a probe housing 40 coupled to the actuator 30, a flange 32 for securing the probe housing 40 to a mating flange 22 on the pipe 24 containing the process stream 20, and a test chamber 50 formed at the end of the actuator 10. As shown, a valve 26 is secured between the pipe 24 and the flange 22. The fouling probe 10 is aligned to be inserted through the flange 22 and the valve 26 before extending into the process stream 20.

As shown in FIG. 1B, the fouling probe 10 has been installed in its operable position, such that the probe housing 40 extends through the valve 26, the chamber 50 is now disposed in the process stream 20, and the flange 32 has been secured to the mating flange 22 on the pipe 24. The valve 26 preferably includes a packing gland 28 providing a fluid seal around the probe housing 40. Accordingly, the probe housing 40 can be retracted out of the valve 26 yet the process fluid will not leak. Once the valve 26 is closed, the probe housing may be fully removed for replacement of the replaceable test wire assembly. The only function of valve 26 is to allow insertion of the probe under pressure without leakage of the process fluid.

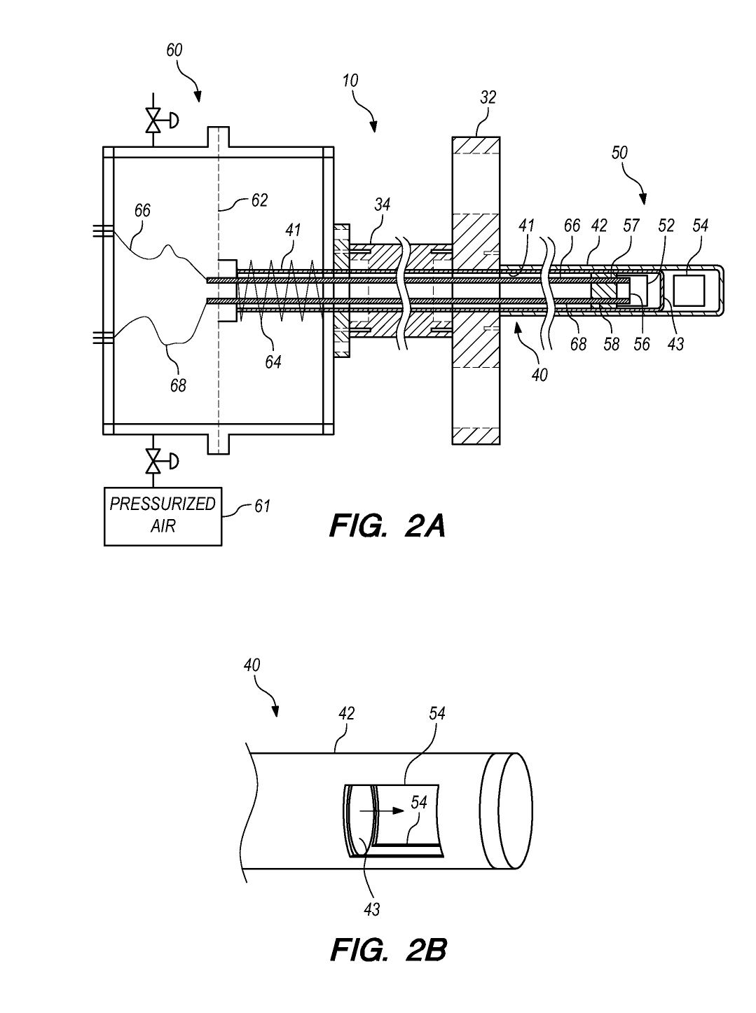

FIG. 2A is a cross-sectional view of a fouling probe 10 having a linear actuator 60 operating the probe housing 40 to position the test chamber 50 in a closed position. The actuator 60 is fixedly secured to the flange 32 by a sleeve 34. Furthermore, an outer concentric cylinder 42 is fixedly secured to the flange 32 such that there is no relative movement between the outer concentric cylinder 42, flange 32, sleeve 34, and actuator 60. However, the actuator 60 includes a diaphragm 62 that is secured around the edges but has a central portion is capable of movement (to the right, as shown) and is coupled to an inner concentric cylindrical member 41. Movement of the diaphragm 62 is controlled by a source of pressurized air 61 that is controllably coupled to a space behind a diaphragm 62. Accordingly, the air pressure on the diaphragm 62 is controlled to position the inner concentric cylinder 41 within the outer concentric cylinder 42. As shown, the air pressure on the diaphragm is low (perhaps atmospheric pressure) such that the diaphragm is relaxed and a spring 64 biases the inner concentric cylinder 41 to a neutral or retracted position. In this position, inlet and outlet windows 52 in the inner concentric cylinder 41 are axially misaligned with the inlet and outlet windows 54 in the outer concentric cylinder 42. Accordingly, the test chamber 50 containing the test wires 56 has a closed end 43 such that the chamber experiences static fluid flow conditions.

It is not important for the chamber 50 to be sealed so long that there is sufficient resistant to fluid flow through the chamber. Accordingly, a fouling test can be conducted in static fluid conditions with the probe in the position shown in FIG. 2A. Electrical current is provided through the test wire 56 (only one shown) via wires 66, 68 that extend through the actuator and inner concentric cylinder to the posts 57, 58 that support the ends of the test wire 56. The slack in the wires 66, 68 accommodates movement of the diaphragm. While the linear actuator shown is powered by pressurized air, such as instrument air, the linear actuator may be an electrically operated linear actuator.

FIG. 2B is a perspective view of the end of the probe housing 40 that forms the test chamber. In this closed position corresponding to FIG. 2A, the inlet and outlet windows 54 through the outer concentric cylinder 42 allow process fluid to pass therethrough, but the end 43 of the inner concentric cylinder 41 prevents the process fluid from entering the chamber around the test wires.

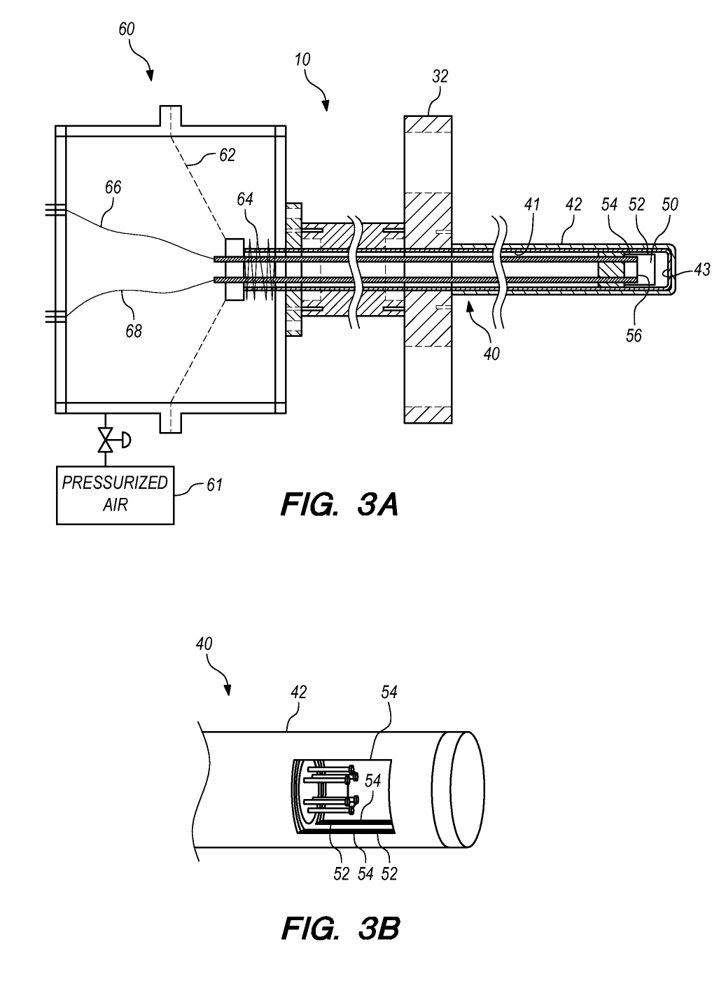

FIG. 3A is a cross-sectional view of the fouling probe 10 of FIGS. 2A-2B when the linear actuator 60 has positioned the test chamber 50 in an open position. Specifically, the source of pressurized air 61 has applied a pressure against the diaphragm 62 and pushed the diaphragm 62 to the right (as shown in FIG. 3A). The pressure has overcome the bias in the spring 64 and moved the inner concentric cylinder 41 to the end of the outer concentric cylinder 43. As a result, the inlet and outlet windows 52 through the inner concentric cylinder 41 are now aligned with the inlet and outlet windows 54 through the outer concentric cylinder 42 such that the process fluid can flow through the open chamber 50.

FIG. 3B is a perspective view of the end of the probe housing 40 that forms the test chamber. In this open position corresponding to FIG. 3A, the inlet and outlet windows 52 are aligned with the inlet and outlet windows 54 such that process fluid is allowed to flow through the chamber 50. If a fouling test had been previously performed, that sample of process fluid is flushed out of the chamber. A further sample of the process fluid may be captured by releasing the air pressure in the actuator 60 so that the spring 64 will move the inner concentric cylinder 41 back to the closed position of FIGS. 2A-2B.

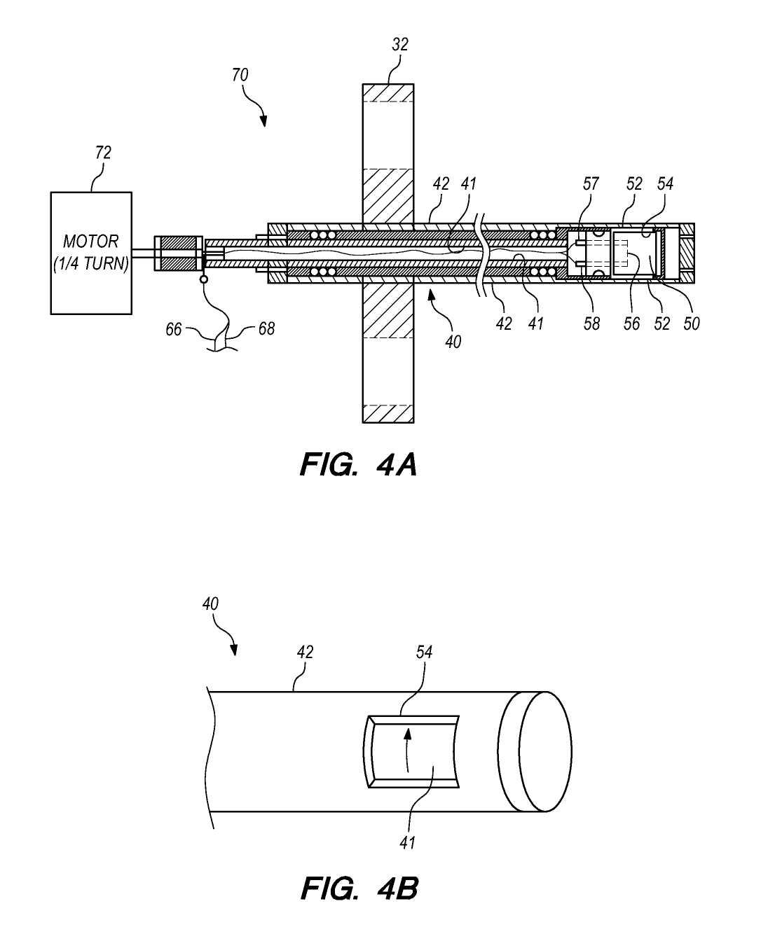

FIG. 4A is a cross-sectional view of a fouling probe 70 having a rotary actuator 72 positioning a test chamber 50 in a closed position. The rotary actuator 72 may, for example, be an electric motor that controllably move a quarter (¼) turn. The actuator 72 is coupled to the inner concentric cylinder 41, whereas the outer concentric cylinder 42 is fixedly secured to the flange 32. Therefore, activating the actuator 72 causes the inner concentric cylinder 41 to rotate within the outer concentric cylinder 42. In the closed position of the chamber 50 as shown, the inlet and outlet windows 52 of the inner concentric cylinder 41 are rotationally misaligned (up and down, as shown) from the inlet and outlet windows 54 of the outer concentric cylinder 42 (forward and back, as shown). As a result, no process fluid can flow in or out of the chamber 50. Note that the wires 66, 68 extend through the side of the inner concentric cylinder 41 and pass through the cylinder 41 to the posts 57, 58 that secured the ends of the test wire 56.

FIG. 4B is a perspective view of the end of the probe housing 40 of the fouling probe 70 of FIG. 4A. The outer concentric cylinder 42 has its inlet and outlet windows 54 (only one shown) in a fixed horizontal orientation, wherein the inlet and outlet windows 52 of the inner concentric cylinder 41 are presently vertically oriented. Accordingly, the walls of the inner concentric cylinder 41 block the inlet and outlet windows 54 to prevent any process fluids from flowing through the chamber.

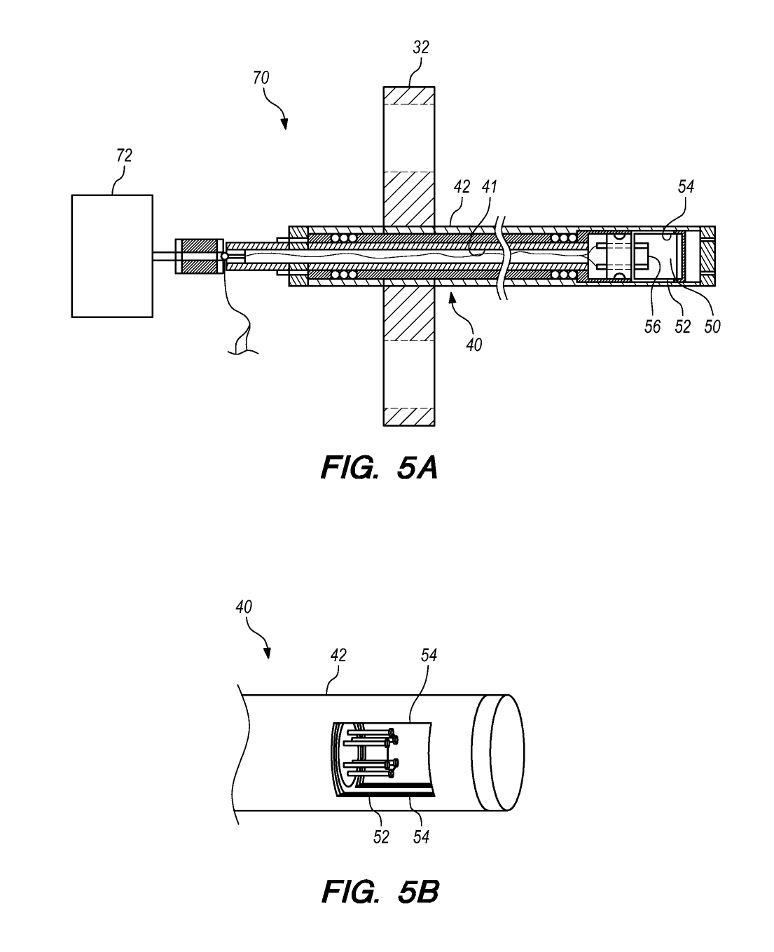

FIG. 5A is a cross-sectional view of the fouling probe 70 of FIGS. 4A-4B when the rotary actuator 72 has rotated the inner concentric cylinder 41 a quarter turn to position the test chamber 50 in an open position. As shown, the inlet and outlet windows 52 of the inner concentric cylinder 41 are aligned with the inlet and outlet windows 52 in the outer concentric cylinder 42 so that process fluid can flow into and through the chamber 50.

FIG. 5B is a perspective view of the end of the probe housing 40 of the fouling probe 70 of FIG. 5A. As shown, the quarter turn of the inner concentric cylinder 41 has aligned the inlet and outlet windows 52 of the inner concentric cylinder 41 with the inlet and outlet windows 54 so that the test chamber 50 is open to the flow of process fluid.

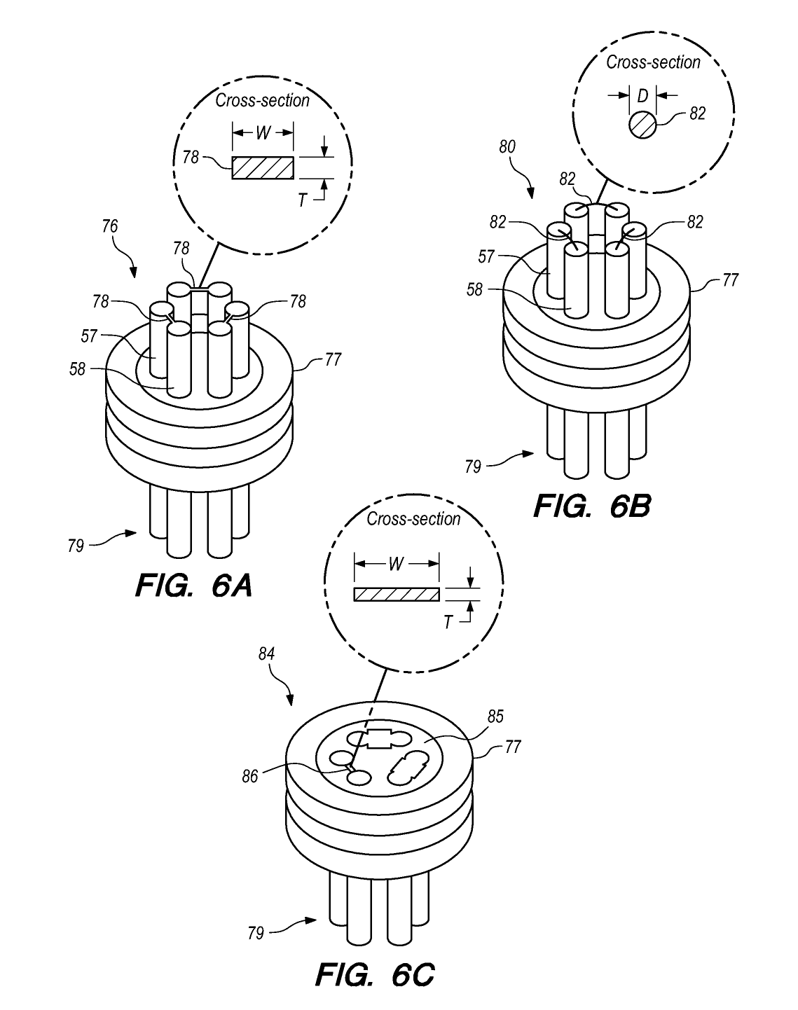

FIGS. 6A-6C are perspective views of three replaceable test wire assemblies. FIG. 6A is a perspective view of a first replaceable test wire assembly 76 having a cylindrical sleeve 77, three pairs of posts 57, 58, and three test wires 78 extending between the three pairs of posts. Each of the test wires 78 has a known length (L) and a rectangular cross-section, including a width (W) and thickness (T). FIG. 6B is a perspective view of a second replaceable test wire assembly 80 having a cylindrical sleeve 77, three pairs of posts 57, 58, and three test wires 82 extending between the three pairs of posts. Each of the test wires 82 has a known length (L) and a circular cross-section defined by a diameter (D). FIG. 6C is a perspective view of a first replaceable test wire assembly 84 having a cylindrical sleeve 77, a non-conductive substrate 85, and a test wire 86 extending between the a pair of pads. Each of the test wires 86 is formed directly on the flat substrate 85 and has a known length (L) and a rectangular cross-section, including a width (W) and thickness (T).

Note that each of the replaceable test wire assemblies 76, 80, 84 form a connector 79 on a side of the assembly opposite of the test wires. The connector 79 may take the form of a plurality of posts that are pluggable into a mating electrical connector having an equal number of receptacles for receiving the posts and electrically connecting the posts to individual wires 66, 68. Optionally, the cylindrical sleeve 77 has a circumferential groove adapted to receive an o-ring to seal the assembly into the inner concentric cylinder 41. Alternatively, the replaceable test wire assemblies would have external threads that couple with internal threads on the inside surface of the inner concentric cylinder 41.

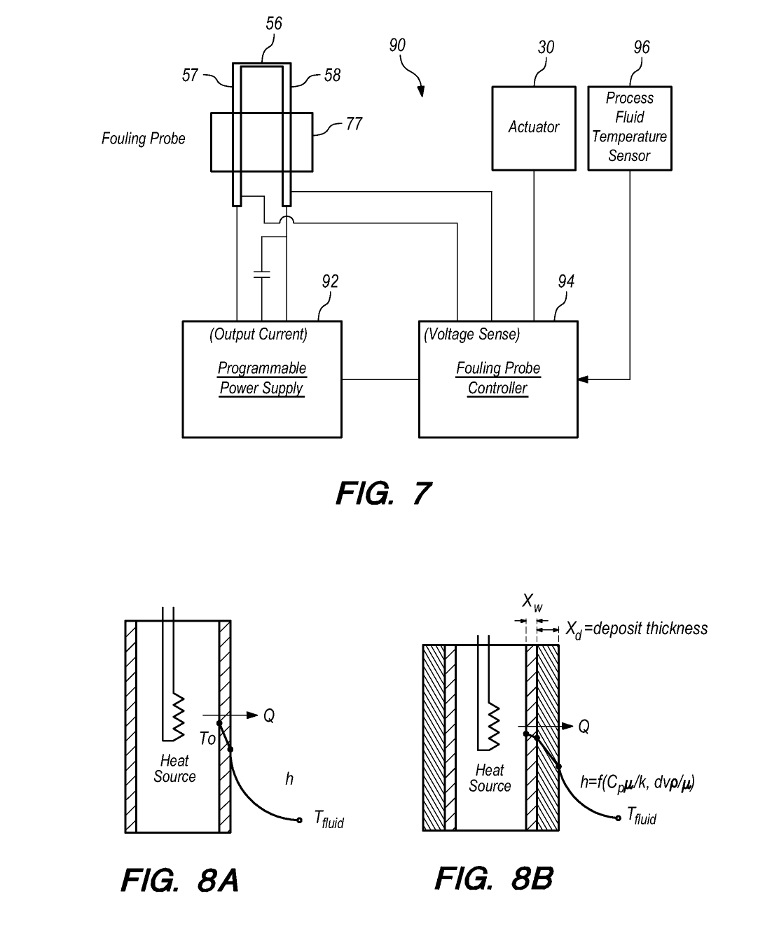

FIG. 7 is a diagram of a control system 90 for a fouling probe having a test wire 56 extending between two posts 57, 58 secured in a sleeve 77. A fouling probe controller 94, which may be a computer, provides a control signal to the actuator 30 in order to control the capture of process fluid samples and the static flow conditions in at test chamber during a fouling test. When a process fluid sample has been captured, the fouling probe controller 94 may instruct a programmable power supply 92 to provide electrical current to the test wire 56. The fouling probe controller 94 also includes voltage sense inputs for measuring the voltage across the test wire 56. In order to carry out calculations of the extent of fouling consistent with certain embodiments, the fouling probe controller 94 may also receive an input signal from a process fluid temperature sensor 96.

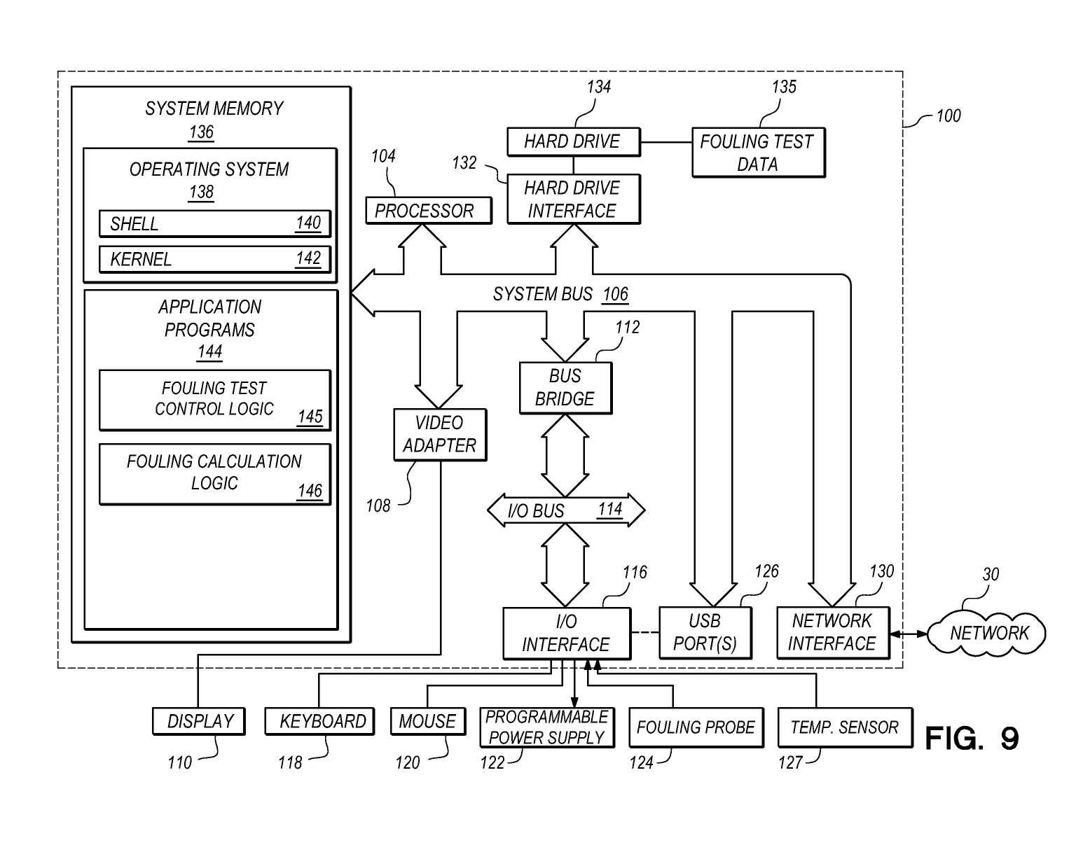

FIG. 9 is a diagram of a fouling probe controller 100 in the form of a computer that may be utilized consistent with one or more embodiments of the present invention. The computer 100 includes a processor unit 104 that is coupled to a system bus 106. Processor unit 104 may utilize one or more processors, each of which has one or more processor cores. A video adapter 108, which drives/supports a display 110, is also coupled to the system bus 106. The system bus 106 is coupled via a bus bridge 112 to an input/output (I/O) bus 114, and an I/O interface 116 is coupled to I/O bus 114. The I/O interface 116 affords communication with various I/O devices, including a keyboard 118, a mouse 120, a programmable power supply 122, a fouling probe (actuator and voltage sense) 124, and a process fluid temperature sensor 126. While the format of the ports connected to the I/O interface 116 may be any format known to those skilled in the art of computer architecture, in a preferred embodiment some or all of these ports are universal serial bus (USB) ports. As depicted, the computer 100 is able to communicate over a network 30 using a network interface 130.

A hard drive interface 132 is also coupled to system bus 106. The hard drive interface 132 interfaces with a hard drive 134. In a preferred embodiment, the hard drive 134 populates a system memory 136, which is also coupled to the system bus 106. System memory is defined as a lowest level of volatile memory in the computer 100. This volatile memory includes additional higher levels of volatile memory (not shown), including, but not limited to, cache memory, registers and buffers. Data that populates the system memory 136 includes the operating system (OS) 138 and application programs 144 for the computer 100.

The operating system 138 includes a shell 140, for providing transparent user access to resources such as application programs 144. Generally, the shell 140 is a program that provides an interpreter and an interface between the user and the operating system. More specifically, the shell 140 executes commands that are entered into a command line user interface or from a file. Thus, the shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while the shell 140 is a text-based, line-oriented user interface, the present invention will equally well support other user interface modes, such as graphical, voice, gestural, etc.

As depicted, the OS 138 also includes a kernel 142, which includes lower levels of functionality for the OS 138, including providing essential services required by other parts of the OS 138 and the application programs 144, including memory management, process and task management, disk management, and mouse and keyboard management. The application programs 144 in the system memory of the computer 100 may include various application programs and modules for implementing the methods described herein, such as fouling test control logic 145 and fouling calculation logic 146. Furthermore, the hard drive 134, or alternative data storage, may store fouling data 135.

The hardware elements depicted in the computer 100 are not intended to be exhaustive, but rather are representative components suitable to perform the processes of the present invention. For instance, the computer 100 may include alternate memory storage devices such as magnetic cassettes, digital versatile disks (DVDs), Bernoulli cartridges, and the like. These and other variations are intended to be within the scope of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of conducting a fouling test, comprising:
positioning a test probe into a process fluid, wherein the test probe includes a test chamber containing a plurality of test wires, and wherein the test chamber includes an inlet window on a first side of the test chamber and an outlet window on a second side of the test chamber;
opening the inlet and outlet windows to allow process fluid to flow through the chamber;
closing the inlet and outlet windows to capture a sample of the process fluid within the chamber;
independently controlling an amount of electrical current to one or more of the test wires while the inlet and outlet windows are closed; and
determining an amount of foulant accumulation on the one or more test wires using heat transfer measurement to determine a fouling factor.

2. The method of claim 1, further comprising:
measuring the voltage on each of the one or more test wires, wherein determining an amount of foulant accumulation on the one or more test wires includes calculating the amount of foulant accumulation as a function of the controlled amount of electrical current and the measured voltage.

3. The method of claim 2, wherein calculating the amount of foulant accumulation is also a function of the process fluid temperature.

4. The method of claim 1, wherein the amount of electrical current provided to the one or more test wires is independently controlled to cause the one or more test wires to reach a different target temperature.

5. The method of claim 4, wherein the one or more test wires are independently controlled to perform simultaneous fouling tests.

6. The method of claim 1, wherein the plurality of test wires are independently controlled to perform sequential fouling tests.

7. The method of claim 6, wherein the sequential fouling tests are performed automatically at regular intervals.

8. The method of claim 1, further comprising:
opening the inlet and outlet windows to allow the process fluid to flow through the chamber and flush out the sample of process fluid from a first fouling test; and
closing the inlet and outlet windows to capture a second sample of the process fluid within the chamber.

9. The method of claim 1, further comprising:
opening the inlet and outlet windows to allow the process fluid to flow through the chamber and flush out the sample of process fluid from a first fouling test;
closing the inlet and outlet windows to capture a second sample of the process fluid within the chamber;
independently controlling an amount of electrical current or voltage to one or more other test wires while the inlet and outlet windows are closed; and
determining an amount of foulant accumulation on the one or more other test wires.

10. The method of claim 1, wherein opening and closing of the inlet and outlet windows is controlled by a linear actuator.

11. The method of claim 1, wherein opening and closing of the inlet and outlet windows is controlled by a rotary actuator.

12. The method of claim 1, further comprising:
replacing the test probe in response to each of the test wires having been used to perform a fouling test.

13. The method of claim 1, wherein the plurality of test wires have the same length and cross-sectional dimensions.

14. The method of claim 1, wherein the plurality of test wires have a length less than 10 millimeters.

15. The method of claim 1, wherein the amount electrical power to each of the test wires is less than 5 watts.

16. The method of claim 1, wherein determining an amount of foulant accumulation on the one or more test wires includes using a heat transfer measurement on the one or more test wires to determine a fouling factor.

17. A fouling test probe, comprising:
a chamber containing a plurality of test wires, wherein the plurality of test wires are secured to a replaceable test wire assembly;
an actuator for selectively opening and closing inlet and outlet windows to the chamber;
a controller controlling the actuator and independently controlling an amount of electrical current to the each of the plurality of test wires; and
a voltage sensor for measuring the voltage across each test wire and providing a voltage signal to the controller.

18. The apparatus of claim 17, wherein the actuator is a linear actuator, and wherein the chamber is formed by inner and outer concentric cylinders, wherein the inner concentric cylinder secures the one or more test wires, has a closed end and forms opposing inlet and outlet windows radially separated by cylindrical walls, wherein the outer concentric cylinder forms opposing inlet and outlet windows radially separated by cylindrical walls, and wherein the chamber is open to process fluid by extending the inner concentric cylinder to align the inlet and outlet windows of the inner concentric cylinder with the inlet and outlet windows of the outer concentric cylinder and closed to process fluid by retracting the inner concentric cylinder to align the inlet and outlet windows of the inner concentric cylinder with cylindrical walls of the outer concentric cylinder.

19. The apparatus of claim 17, wherein the actuator is a rotary actuator, and wherein the chamber is formed by inner and outer concentric cylinders, wherein the inner concentric cylinder secures the one or more test wires and forms opposing inlet and outlet windows radially separated by cylindrical walls, wherein the outer concentric cylinder forms opposing inlet and outlet windows radially separated by cylindrical walls, and wherein the chamber is open to process fluid by radially aligning the inlet and outlet windows of the outer concentric cylinder with the inlet and outlet windows of the inner concentric cylinder and closed to process fluid by radially aligning the cylindrical walls of the outer concentric cylinder with the inlet and outlet windows of the inner concentric cylinder.

20. The apparatus of claim 17, wherein each of the test wires has a rectangular cross section.

21. The apparatus of claim 17, wherein each of the test wires has a circular cross section.

22. The apparatus of claim 17, wherein each of the test wires have the same length and cross-sectional dimensions.

23. The apparatus of claim 17, wherein the plurality of test wires have a length less than 5 millimeters.

24. The apparatus of claim 17, wherein each of the test wires is made with the same material, and wherein the material is selected from nickel, 316 stainless steel, and steel.

25. The apparatus of claim 17, wherein the test wires are disposed directly on an electrically non-conductive substrate.

26. The apparatus of claim 17, wherein the probe extends into a process stream containing the process fluid to be tested.

27. The apparatus of claim 26, wherein the process fluid is a hydrocarbon.

28. The apparatus of claim 17, wherein the replaceable test wire assembly includes an electrically non-conductive base plate securing a plurality of electrically conductive posts extending from the base plate, wherein each of the test wires has a first end coupled to a first one of the electrically conductive posts and a second end coupled to a second one of the electrically conductive posts.

29. The apparatus of claim 28, wherein the replaceable test wire assembly includes an electrical connector for disconnectably connecting the plurality of electrically conductive posts to a plurality of conductor wires for independently providing electrical current to the each of the test wires.
